(19) United States
(12) Patent Application Publication
(10) Pub. No.: US 2021/0374620 A1
(43) Pub. Date: Dec. 2, 2021

(54) INFORMATION PROCESSING DEVICE AND NON-TRANSITORY COMPUTER READABLE MEDIUM

(71) Applicant: FUJIFILM BUSINESS INNOVATION CORP., Tokyo (JP)

(72) Inventors: Kengo Tokuchi, Kanagawa (JP); Toru Hatori, Kanagawa (JP); Naoyasu Terao, Kanagawa (JP); Nobuyuki Yamazoe, Kanagawa (JP)

(73) Assignee: FUJIFILM BUSINESS INNOVATION CORP., Tokyo (JP)

(21) Appl. No.: 17/086,613

(22) Filed: Nov. 2, 2020

(30) Foreign Application Priority Data
Jun. 2, 2020 (JP) 2020-095919

(51) Int. Cl. G06Q 10/02; G06Q 10/06; G06Q 10/10

(52) U.S. Cl. CPC G06Q 10/02; G06Q 10/109; G06Q 10/06312

(57) ABSTRACT

An information processing device includes a processor configured to, in a case of receiving a reservation for a space that is usable by making a reservation, determine whether a time period of the reservation is consecutive with a time period of an already-registered reservation without an empty time in between, and if the time periods of the reservations are consecutive without an empty time in between, notify a reserver with guidance information.

### CROSS-REFERENCE TO RELATED APPLICATIONS

This application is based on and claims priority under 35 USC 119 from Japanese Patent Application No. 2020-095919 filed Jun. 2, 2020.

### BACKGROUND

### (i) Technical Field

The present disclosure relates to an information processing device and a non-transitory computer readable medium.

### (ii) Related Art

A reservation order management device has been proposed (see Japanese Unexamined Patent Application Publication No. 2013-210864). The reservation order management device is provided with: a deciding means that decides a reservation order of multiple reservation targets by a reserver (that is, a person who makes a reservation) on the basis of a predetermined rule; a confirmation information transmitting means that transmits confirmation information for confirming whether to change the reservation order to a portable terminal device carried by the reserver; an acknowledgment information receiving means that receives acknowledgment information indicating either an acceptance or a rejection transmitted from the portable terminal device in response to the confirmation information transmitted by the confirmation information transmitting means; an adjusting means that adjusts the reservation order decided by the deciding means in the case where the acknowledgment information received by the acknowledgment information receiving means indicates an acceptance; and an adjustment result information transmitting means that transmits adjustment result information indicating a result of adjusting the reservation order by the adjusting means to the portable terminal device.

A reservation system that uses a server and a client terminal connected over a network has also been proposed (see Japanese Unexamined Patent Application Publication No. 2002-329111). The reservation system is provided with: a first log acquiring means that displays a reservation target on a browser screen of the client terminal, receives the designation of a specific reservation target on the browser screen, and creates an access log as a log file; and a second log acquiring means that determines whether or not a reservation slot of the designated reservation target is filled, and if the reservation slot is filled, displays a reservation rejection screen on the browser screen and also creates a reservation rejection log as a log file. The first and second logs are acquired for each member specified by a member ID.

### SUMMARY

Aspects of non-limiting embodiments of the present disclosure relate to receiving a reservation according to the air environment of a space that is usable by making a reservation.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided an information processing device including a processor configured to, in a case of receiving a reservation for a space that is usable by making a reservation, determine whether a time period of the reservation is consecutive with a time period of an already-registered reservation without an empty time in between, and if the time periods of the reservations are consecutive without an empty time in between, notify a reserver with guidance information.

### BRIEF DESCRIPTION OF THE DRAWINGS

Exemplary embodiments of the present disclosure will be described in detail based on the following figures, wherein:

FIG. 1 is a diagram schematically illustrating an example of an overall configuration of a reservation system;

FIG. 2 is a simplified perspective view illustrating an internal configuration of a booth as an example of a space that is usable by making a reservation in the reservation system;

FIG. 3 is a diagram for explaining an example of a hardware configuration used by a reserver terminal and management servers;

FIG. 4 is a diagram for explaining an example of a functional configuration of a reservation management server;

FIG. 5 is a diagram for explaining an example of a reservation reception screen displayed on a display device of the reserver terminal;

FIG. 6 is a flowchart illustrating the flow of operations for receiving a reservation executed by the reservation management server;

FIG. 7 is a diagram for explaining an example of a reservation reception screen in a state of receiving a reservation displayed on the display device of the reserver terminal;

FIG. 8 is a diagram illustrating an example of a first error message displayed on the display device of the reserver terminal;

FIG. 9 is a diagram illustrating an example of a second error message displayed on the display device of the reserver terminal;

FIG. 10 is a diagram illustrating an example of a third error message displayed on the display device of the reserver terminal;

FIG. 11 is a diagram illustrating an example of a fourth error message displayed on the display device of the reserver terminal;

FIG. 12 is a diagram illustrating an example of a fifth error message displayed on the display device of the reserver terminal;

FIG. 13 is a flowchart illustrating a flow of operations for receiving a reservation according to a second exemplary embodiment, the operations being executed by the reservation management server;

FIG. 14 is a diagram illustrating an example of a sixth error message displayed on the display device of the reserver terminal;

FIG. 15 is a flowchart illustrating a flow of operations for receiving a reservation according to an exemplary modification 1, the operations being executed by the reservation management server;

FIG. 16 is a diagram illustrating an example of a seventh error message displayed on the display device of the reserver terminal;

FIG. 17 is a flowchart illustrating a flow of operations for receiving a reservation according to an exemplary modification 2, the operations being executed by the reservation management server; and

FIG. 18 is a diagram illustrating an example of an eighth error message displayed on the display device of the reserver terminal.

### DETAILED DESCRIPTION

Hereinafter, exemplary embodiments and specific examples will be used to describe the present disclosure in further detail and with reference to the drawings, but the present disclosure is not limited to these exemplary embodiments and specific examples.

Also, it should be noted that the drawings referenced in the following description are schematic diagrams, and features such as the ratios of dimensions may differ from actual dimensions. Furthermore, features other than members relevant to the description may be omitted from illustration where appropriate for simplicity.

### First Exemplary Embodiment

### (1) Overall Configuration of Reservation System

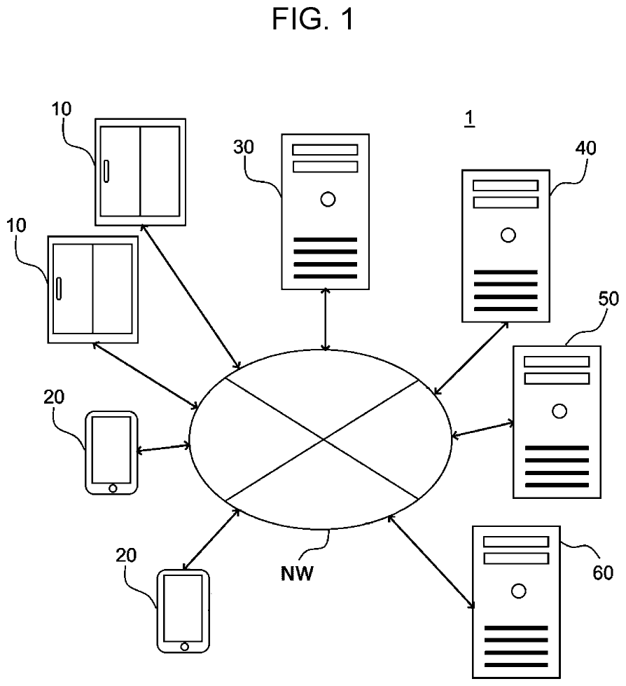

FIG. 1 is a diagram schematically illustrating an example of an overall configuration of a reservation system 1.

Hereinafter, an overall configuration of the reservation system 1 will be described with reference to the drawing.

As illustrated in FIG. 1, the reservation system 1 includes various terminals connected to a cloud network NW.

The reservation system 1 includes spaces 10 that are usable by making a reservation, reserver terminals 20 operated by reservers, a reservation management server 30 that manages reservations of the spaces 10, a space management server 40 that manages the conditions of use of the spaces 10, a billing management server 50 that manages billing to reservers, and a member management server 60 that manages information about reservers able to use the spaces 10.

Note that examples of the spaces 10 in the exemplary embodiment include personal booths installed indoors or outdoors in various locations, including inside a train or subway station, an airport, an office building, a commercial facility such as a restaurant or a department store, a bank, a library, an art gallery, a museum, a public institution or facility, a passageway, or a park, and furthermore include rest spaces in a restaurant, karaoke boxes, and automobiles in a transportation service.

In the example illustrated in FIG. 1, individual servers are prepared for separate purposes or functions, but multiple servers may also be prepared for a single purpose, or a single server may be responsible for handling multiple purposes or functions. The business that provides the service for reserving the spaces 10 may be a single entity or multiple entities. For example, the management of reservations, the management of conditions such as entry/exit and usage inside a space, the management related to the billing of usage fees to users, and the management of members registered as users may each be handled by different businesses. Also, the management related to a single purpose of function may also be provided through the cooperation of multiple businesses. In addition, the spaces 10 may not only be provided by a single business, but may also be provided by multiple businesses.

In the case of the exemplary embodiment, an electronic key is used to lock and unlock each space 10, and an electronic key is stored in each portable reserver terminal 20 or in an integrated circuit (IC) card that supports short-range wireless communication (not illustrated).

In the exemplary embodiment, a smartphone is anticipated as the portable reserver terminal 20, but the portable reserver terminal 20 may also be what is called a wearable terminal or a bearable terminal provided with a speech input/output interface, or a game console provided with a function for communicating on the Internet.

In the case of using the reserver terminal 20 as an electronic key, an electronic key is transmitted from the reservation management server 30 to the reserver terminal 20 after a reservation is confirmed. In the case of using an IC card as an electronic key, an IC card with an electronic key recorded thereon is distributed from the reservation management server 30 to the reserver after a reservation is confirmed.

Note that multiple physical keys may also be prepared for different reservation times and used to lock or unlock each space 10. Additionally, an authentication of the reserver may be used instead of a key, or an authentication of the reserver may be used as a complement to an electronic or physical key.

The reservation management server 30 manages various information related to reservations, for example. The reservation management server 30 in the exemplary embodiment accepts reservations of the spaces 10 for 24 hours a day, 365 days a year, except during times set aside for maintenance or the like.

The reservation management server 30 may also execute processes for issuing an electronic key and authenticating the reserver terminal 20 where appropriate. Note that an authentication process may also be performed by the space management server 40.

The space management server 40 manages the entry and exit of reservers with respect to the individual spaces 10 and the usage conditions of the individual spaces 10, for example. Additionally, the space management server 40 communicates with an authentication unit (not illustrated) disposed in each space 10 to permit or deny the entry of a reserver, for example. During such authentication, the space management server 40 communicates with devices such as the reservation management server 30.

The space management server 40 also collects information from various equipment disposed inside or outside the spaces 10. Examples of the various equipment include human presence sensors, surveillance cameras, temperature sensors, humidity sensors, illumination sensors, and odor sensors.

Also, the space management server 40 controls operations by various equipment disposed in the spaces 10. In the case of the exemplary embodiment, the reservation management server 30 controls equipment related to reservations. In the example of FIG. 1, the space management server 40 is disposed on the cloud network NW, but some or all of the functions of the space management server 40 may also be provided by a control device in each space 10.

The billing management server 50 has a function of issuing a bill to each member on the basis of information such as reservation information, information about the reserver, and entry/exit information. Herein, a “member” may be an individual or a corporation. The billing management server 50 acquires reservation information from the reservation management server 30, entry/exit information from the space management server 40, and member information from the member management server 60.

The member management server 60 manages information about registered members and information about reservers. In the case where the member is an individual, the member and the reserver are the same person. On the other hand, in the case where the member is a corporation, individual reservers are registered and managed for each member.

### (2) Overall Configuration of Space

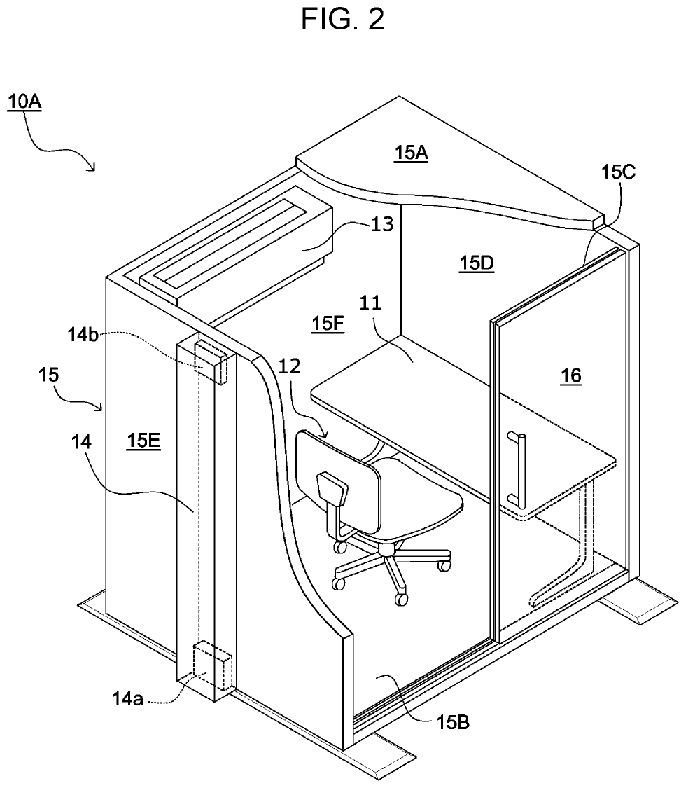

FIG. 2 is a simplified perspective view illustrating an internal configuration of a booth 10A as an example of one of the spaces 10 that is usable by making a reservation in the reservation system according to the exemplary embodiment.

The booth 10A illustrated as an example of a space that is usable by making a reservation in the exemplary embodiment is installed indoors or outdoors in any of various locations, including inside a train or subway station, an airport, an office building, a commercial facility such as a restaurant or a department store, a bank, a library, an art gallery, a museum, a public institution or facility, a passageway, or a park.

The booth 10A is box-shaped overall, with a desk 11, a chair 12, and an air conditioner 13 installed inside and an air duct 14 installed on one side, such that a user is able to sit in the chair 12 facing the desk 11 and work or study inside the air-conditioned space formed inside the booth 10A. Also, the booth 10A may be configured to be assembled at a factory or the like, loaded onto the bed of a truck or the like for transport, and installed on a floor FL at a predetermined installation location.

A frame 15 of the booth 10A includes a ceiling 15A, a floor 15B, a wall 15C having an openable door 16 attached, two walls 15D and 15E positioned on either side of the wall 15C, and a wall 15F positioned on the opposite side from the door 16.

In the case of FIG. 2, the air conditioner 13 is provided on the wall 15F, and the air duct 14 that includes an intake port 14a and an exhaust port 14b is disposed on the wall 15E. With this arrangement, an air-conditioned space including ventilation is formed inside the booth 10A.

In the booth 10A according to the exemplary embodiment, the door 16 is anticipated to be a sliding door that is movable parallel to the wall 15C. In the case of FIG. 2, the door 16 is a single-sliding type in which a single door panel slides, but the door 16 may also be a bypass type that opens by sliding two or more door panels past each other, or a double-sliding type in which two door panels slide away from each other. Additionally, an electronic lock (not illustrated) that is unlocked by an electronic key may be attached to the door 16.

The number of persons able to use the booth 10A is roughly determined according to the volume of the booth 10A. The booth 10A in the exemplary embodiment is basically anticipated to be a personal space used by a single person, but the booth 10A may also be a large room capable of accommodating many people. A large room may be formed as a single room, or a large room may be formed by joining multiple booths 10A with either or both of the walls 15D and 15E of the booths 10A removed.

Note that a personal space does not mean a space that is usable only by a single person, but rather means a space demarcated by physical partitions or the like, and the number of persons able to the use the personal space may be a single person or multiple persons.

### (3) Configuration and Functions of Terminal

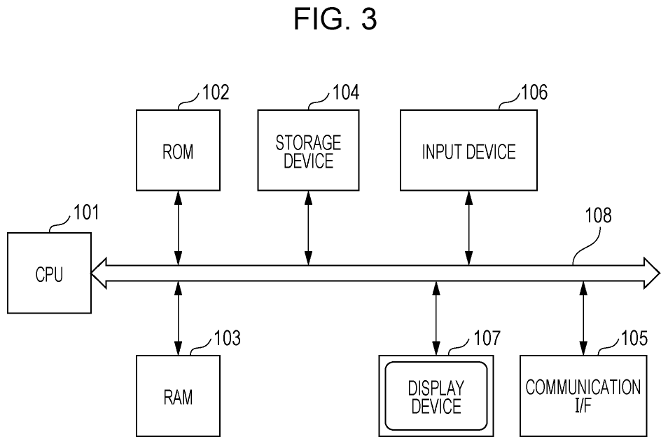

FIG. 3 is a diagram for explaining an example of a hardware configuration used by the reserver terminal 20 (see FIG. 1) and the management servers. Here, the management servers are the reservation management server 30 (see FIG. 1), the space management server 40 (see FIG. 1), the billing management server 50 (see FIG. 1), and the member management server 60 (see FIG. 1).

Each reserver terminal 20 and each management server includes a central processing unit (CPU) 101 that provides various management functions through the execution of programs, read-only memory (ROM) 102 that serves as a storage area for storing information such as a basic input/output system (BIOS), and random access memory (RAM) 103 that is used as an program execution area. The programs include firmware and an operating system.

Note that one or more of each of the CPU, the ROM, and RAM may be provided.

In addition, each reserver terminal 20 and each management server includes a storage device 104 that stores application programs for achieving assigned management functions and also various management data, a communication interface (communication I/F) 105 used to communicate with external equipment, an input device 106 including a device such as a touch panel or a keyboard, and a display device 107 used to display information.

In the case of a portable reserver terminal 20, non-volatile memory is used as the storage device 104 for example, whereas in the case of a non-portable reserver terminal 20 and the management servers, a hard disk drive is used as the storage device 104 for example.

In the case of a portable reserver terminal 20, a touch panel is used as the input device 106 for example. In the case of a non-portable reserver terminal 20 and the management servers, a keyboard and a mouse are used as the input device 106 for example, and a liquid crystal display or an organic electroluminescence (EL) display is used as the display device 107 for example.

The CPU 101 and the various devices are connected through a bus 108 and one or more signal lines not illustrated.

In addition, a microphone used to input sound or speech and a speaker used to output sound or speech may be provided. Similarly, an actuator such as a motor that causes a device to vibrate may also be provided.

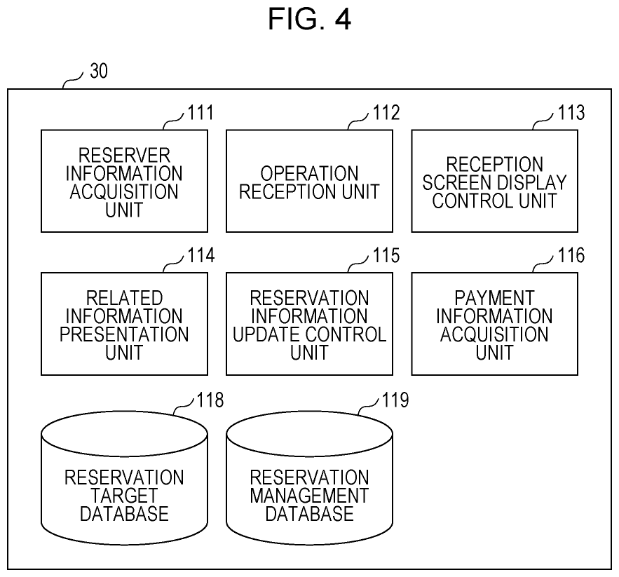

FIG. 4 is a diagram for explaining an example of a functional configuration of the reservation management server 30.

The reservation management server 30 according to the exemplary embodiment functions as a reserver information acquisition unit 111 that acquires information about reservers input through the reservation reception screen, an operation reception unit 112 that receives operations related to reservations, a reception screen display control unit 113 that controls the display of the reservation reception screen, a related information presentation unit 114 that presents information related to the space 10 (see FIG. 1) to be reserved, a reservation information update control unit 115 that controls the updating of reservation information according to changes in an image on the reception screen, and a payment information acquisition unit 116 that acquires payment information used to pay for a reservation.

In the storage device 104 (see FIG. 3) of the reservation management server 30, a reservation target database 118 that stores information about the spaces 10 to be reserved and information related to the spaces 10 and a reservation management database 119 that manages information about confirmed reservations are stored.

Note that all or a portion of these databases may also be placed in a cloud server on the cloud network NW.

The reserver information acquisition unit 111 acquires, from the member management server 60 (see FIG. 1), information related to a name, a member number, an employee number, and the like of a reserver input into the reservation screen or selected on the reservation screen, for example. Also, a reserver who is currently making a reservation may be specified from device information about the reserver terminal 20 (see FIG. 1) being used to make the reservation. Note that the work of making a reservation may also be performed by a secretary or a colleague on behalf of the reserver in some cases, and the person who does the work of making a reservation may not necessarily match the reserver.

The operation reception unit 112 receives the content of an operation performed on the reception screen displayed on the reserver terminal 20 (see FIG. 1). In the exemplary embodiment, the reserver terminal 20 is used as an input/output device, while processing is substantially executed by the reservation management server 30. A specific space 10 (see FIG. 1) that the reserver wants to reserve and reservable time periods are supplied to the operation reception unit 112.

The reception screen display control unit 113 controls the display of the reception screen according to the content of a received operation. On the reception screen, information for reserving the use of a space 10 is displayed, for example. Specific examples of the reception screen will be described later.

The related information presentation unit 114 has a function of presenting information related to the space 10 to be reserved. Information related to the space 10 is stored in the reservation target database 118.

The reservation information update control unit 115 has a function of controlling the updating of reservation information according to changes in the reception screen in association with operations by the reserver. The reservation information is stored in the reservation management database 119.

The payment information acquisition unit 116 acquires payment information used to pay for a reservation through communication with the billing management server 50 (see FIG. 1), and puts the reserved space 10 into a usable state according to the payment status.

The reservation management server 30 is not limited to such a centralized type and may also be a distributed type in which a blockchain is used to manage reservation information by inputting the reservation information into blocks and synchronizing the reservation information between equipment connected to the blockchain, or the reservation information may be shared between equipment in a peer-to-peer (P2P) architecture.

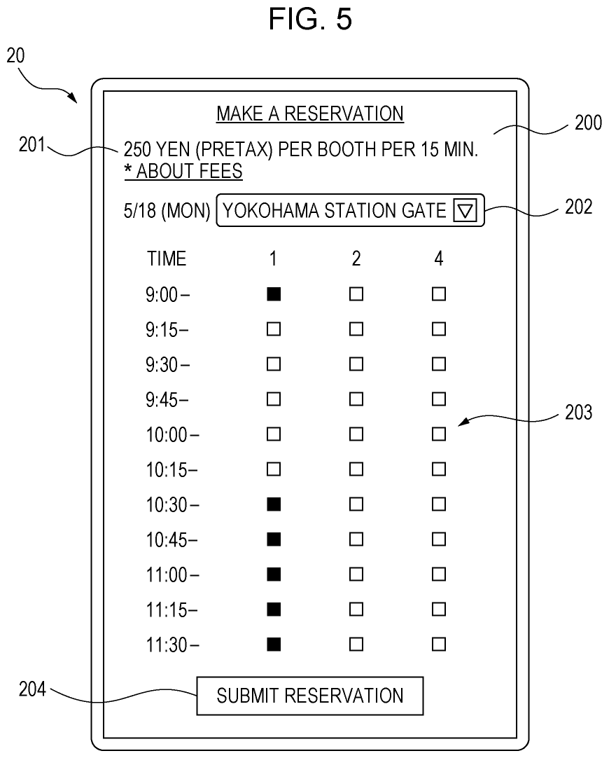

FIG. 5 is a diagram for explaining an example of a reservation reception screen 200 displayed on the display device 107 (see FIG. 3) of the reserver terminal 20.

The reception screen 200 in the exemplary embodiment includes a display field 201 that displays the price of a reservation, a display field 202 that displays information about the space 10 (see FIG. 1) to be reserved, an input field 203 for each time period of the space 10 to reserve, and a confirmation button 204 that gives an instruction to proceed to a confirmation screen. Note that in this case, the space 10 is the booth 10A to be reserved.

In the case of FIG. 5, the day of reservation is “5/18 (Mon), the space 10 (booth 10A) to be reserved is positioned near the ticket gate in Yokohama Station, and for the booth 10A having an ID of 1, the reservable time periods “9:15-9:30”, “9:30-9:45”, “9:45-10:00”, “10:00-10:15”, “10:15-10:30” are indicated by the symbol “□”, while the non-reservable time periods “9:00-9:15”, “10:30-10:45”, “10:45-11:00”, “11:00-11:15”, “11:15-11:30”, “11:30-11:45” are indicated by the symbol “▪”.

### (3) Reservation Management

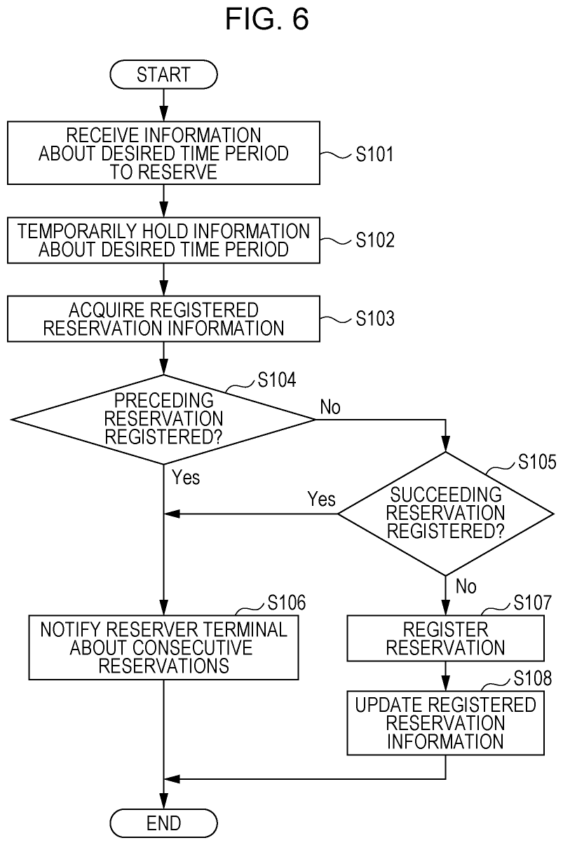

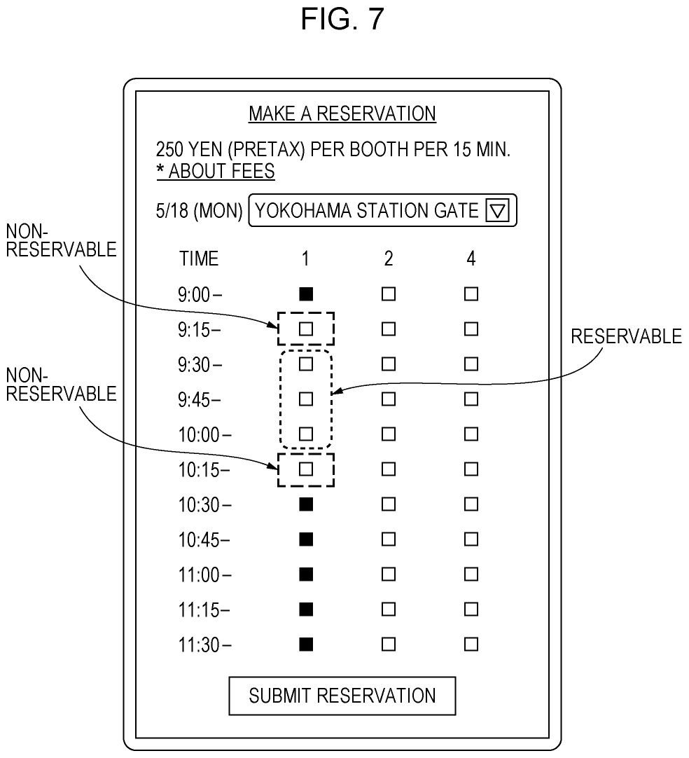

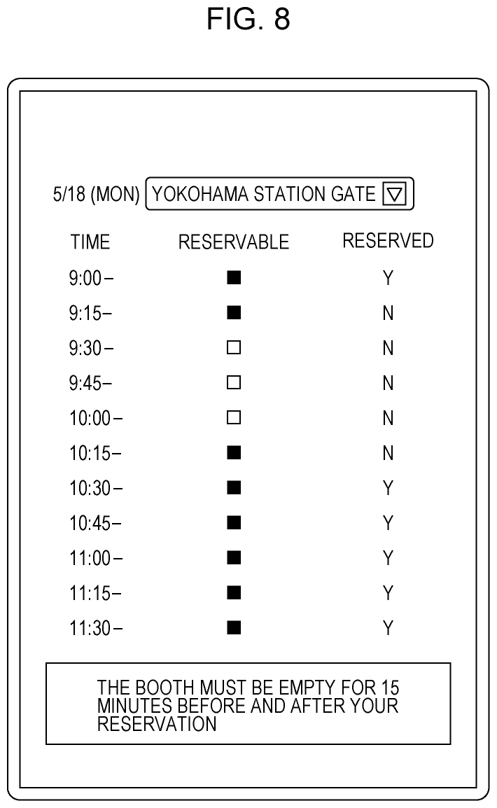

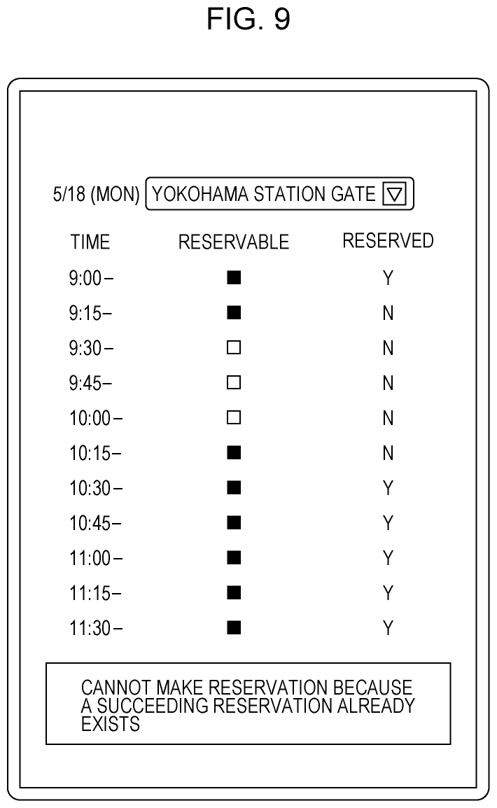

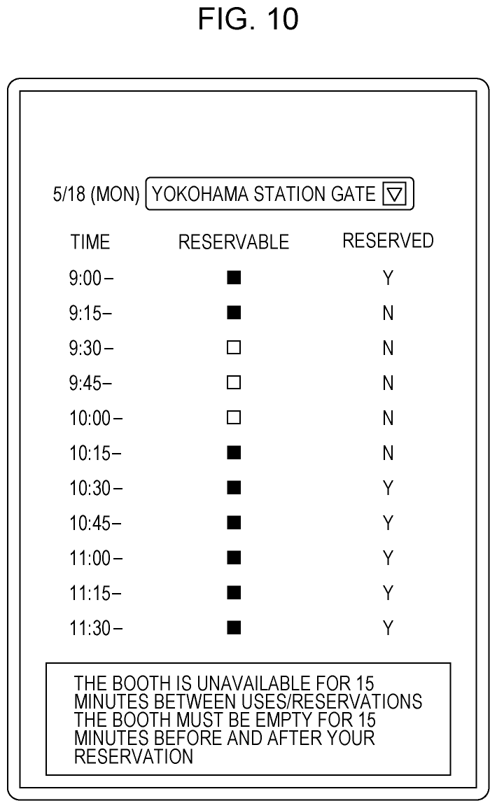

FIG. 6 is a flowchart illustrating the flow of operations for receiving a reservation executed by the reservation management server 30, FIG. 7 is a diagram for explaining an example of the reservation reception screen in a state of receiving a reservation displayed on the display device 107 of the reserver terminal 20, FIG. 8 is a diagram illustrating an example of a first error message displayed on the display device 107 of the reserver terminal 20, FIG. 9 is a diagram illustrating an example of a second error message displayed on the display device 107 of the reserver terminal 20, and FIG. 10 is a diagram illustrating an example of a third error message displayed on the display device 107 of the reserver terminal 20. Note that the reserver may be notified of the message not only by an image, but also by sound or speech. Similarly, the reserver may also be notified by a change in vibration.

In the case of receiving a reservation to use the booth 10A that is usable by making a reservation, the reservation management server 30 that acts as an information processing device according to the exemplary embodiment determines whether the time period of the reservation is consecutive with the time period of an already-registered reservation without an empty time in between, and if the time periods of the reservations are consecutive without an empty time in between, the reservation management server 30 notifies the reserver with guidance information.

As illustrated in FIG. 6, in the reservation management server 30, the operation reception unit 112 receives information about a desired time period during which to reserve the booth 10A transmitted from the reserver terminal 20 (S101), and temporarily holds the desired time period in the reservation management database 119 (S102).

Thereafter, the reservation management server 30 acquires the registered reservation information held in the reservation management database 119 (S103), and determines whether a reservation preceding the time period of the received reservation is registered (S104). In the case of determining that a preceding reservation is registered (S104: Yes), the reserver terminal 20 is notified with guidance information regarding the consecutive reservations through the reservation information update control unit 115 (S106).

In the case where a preceding reservation is not registered (S104: No), it is determined whether a reservation succeeding the time period of the received reservation is registered (S105). In the case of determining that a succeeding reservation is registered (S105: Yes), the reserver terminal 20 is notified with guidance information regarding the consecutive reservations through the reservation information update control unit 115 (S106). In the case where a succeeding reservation is not registered (S105: No), the time period of the received reservation is registered (S107), and the registered reservation information is updated (S108).

With this arrangement, as exemplified in FIG. 7, in the case where a reservation is registered for the period “9:00-9:15” (preceding), the empty period “9:15-9:30” is non-reservable, and in the case where a reservation is registered for the period “10:30-10:45” (succeeding), the period “10:15-10:30” is non-reservable. In this way, by making reservation unavailable in the case where the time period of the reservation is consecutive with another reservation without an empty time in between, consecutive use of the booth 10A by different users is avoided, thereby reducing the risk of infectious diseases and the like.

In the case where the time period of the reservation is consecutive with another reservation without an empty time in between (S104: Yes, or S105: Yes), an error message is displayed on the display device 107 of the reserver terminal 20.

As exemplified in FIG. 8, the error message is a message such as “The booth must be empty for 15 minutes before and after your reservation.”, and instructs the reserver to leave a predetermined reservation time period empty before and after the time period of the reservation.

The error message may also be a message such as “Cannot make reservation because a succeeding reservation already exists.” as exemplified in FIG. 9, or a message such as “The booth is unavailable for 15 minutes between uses/reservations. The booth must be empty for 15 minutes before and after your reservation.” as exemplified in FIG. 10.

### Exemplary Modification 1

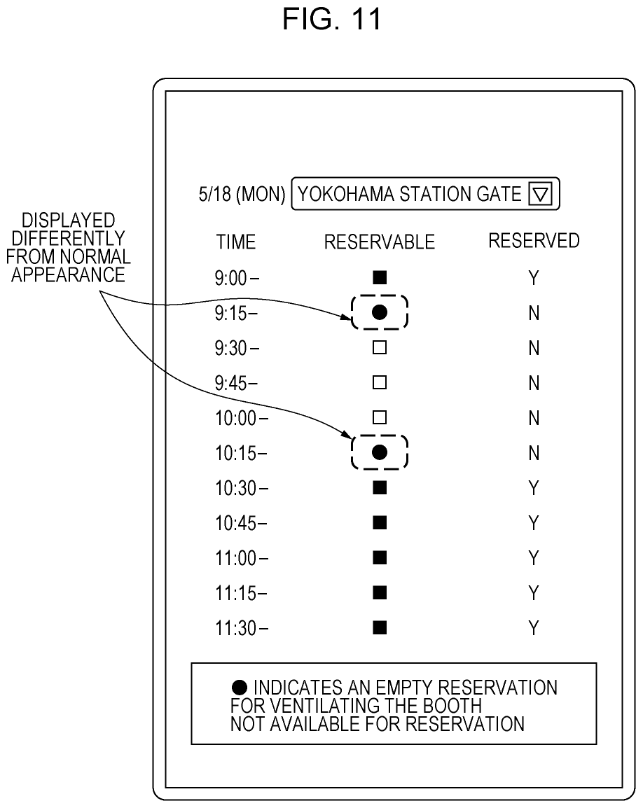

FIG. 11 is a diagram illustrating an example of a fourth error message displayed on the display device 107 of the reserver terminal 20.

It is possible to reserve the time period before or after an already-registered reservation, but the time period before or after is not reservable by a reserver other than the reserver who made the already-registered reservation.

In this case, the reason why reservation is unavailable may be displayed on the display device 107 of the reserver terminal 20 as an error message, while in addition, the relevant time period is displayed differently from the normal appearance.

Specifically, as exemplified in FIG. 11, the periods “9:15-9:30” and “10:15-10:30” are not reservable and are indicated by the “●” symbol different from the normal appearance, and a message such as “This is an empty reservation for ventilating the booth. Not available for reservation.” is displayed.

Obviously, in the case of notifying the reserver with sound or speech, the content of the sound or speech may be changed from the normal notification to inform the reserver. For example, the reserver may be informed with speech such as “This is an empty reservation for ventilating the booth. Not available for reservation.” like the above.

### Exemplary Modification 2

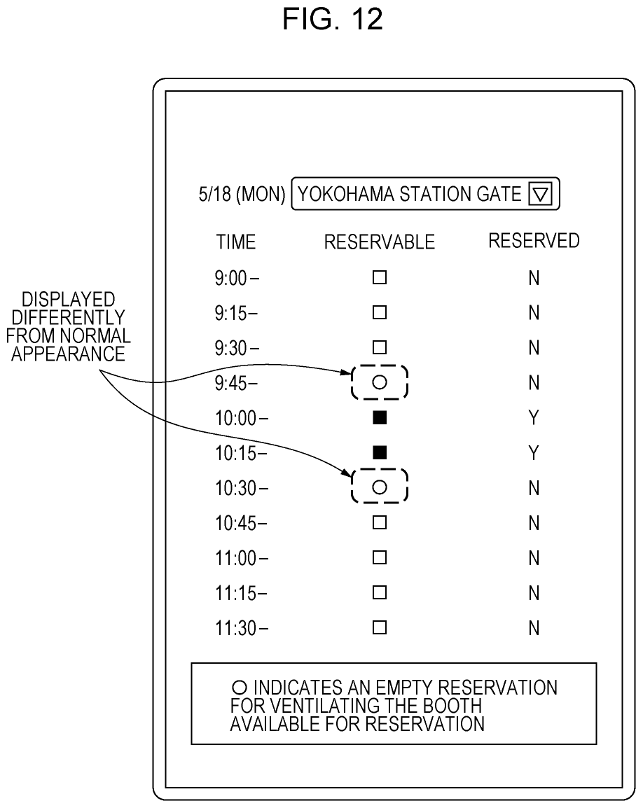

FIG. 12 is a diagram illustrating an example of a fifth error message displayed on the display device 107 of the reserver terminal 20.

The reserver is able to add a new reserved time period consecutive with the time period of an reservation already registered by the same reserver, and the reason why the reserver is able to make the reservation is displayed on the display device 107 of the reserver terminal 20, while in addition, the relevant time period is displayed differently from the normal appearance.

Specifically, as exemplified in FIG. 12, the periods “9:45-10:00” and “10:30-10:45” are reservable and are indicated by the “◯” symbol different from the normal appearance, and a message such as “This is an empty reservation for ventilating the booth. Available for reservation.” is displayed.

Obviously, in the case of notifying the reserver with sound or speech, the content of the sound or speech may be changed from the normal notification to inform the reserver. For example, the reserver may be informed with speech such as “This is an empty reservation for ventilating the booth. Available for reservation.” like the above.

### Second Exemplary Embodiment

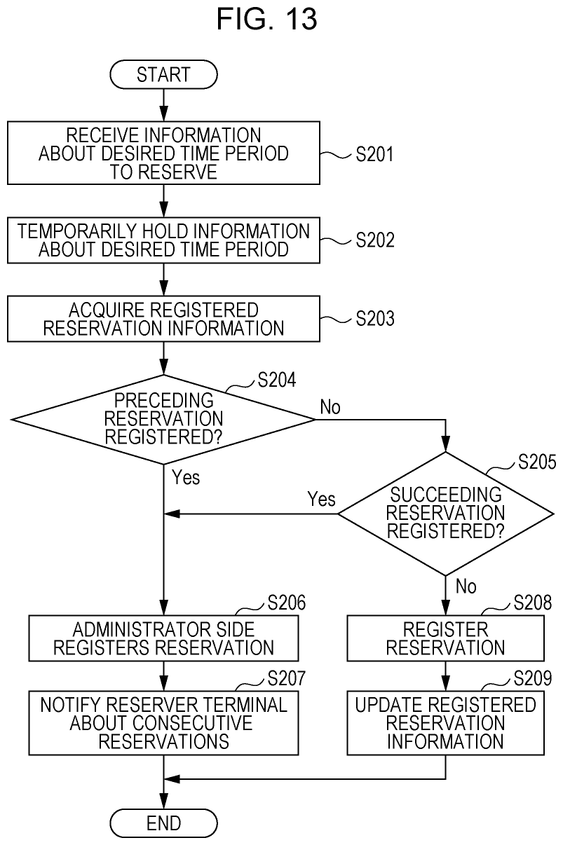

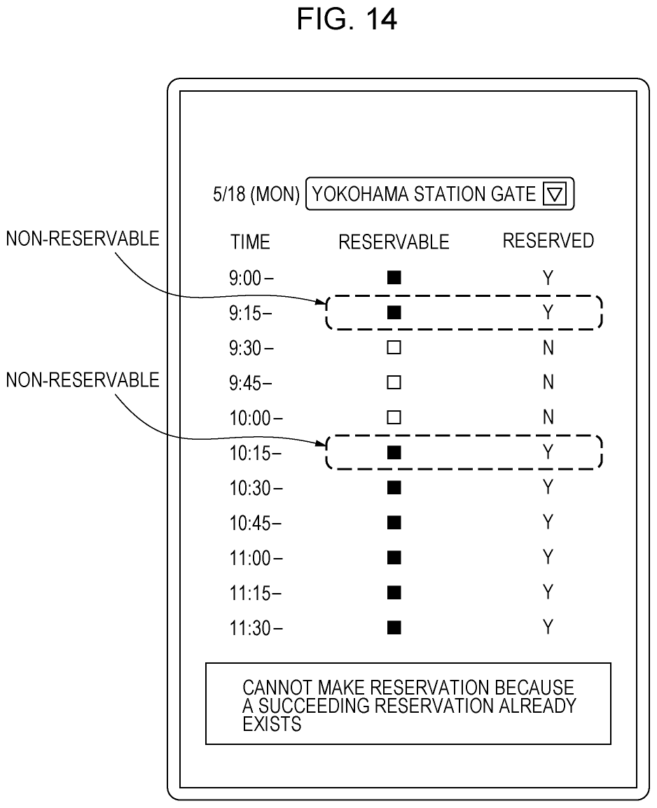

FIG. 13 is a flowchart illustrating a flow of operations for receiving a reservation according to a second exemplary embodiment, the operations being executed by the reservation management server 30, and FIG. 14 is a diagram illustrating an example of a sixth error message displayed on the display device 107 of the reserver terminal 20.

In the case of receiving a reservation for the booth 10A that is usable by making a reservation, the reservation management server 30 adjusts the reservation such that the time period before or after the time period to be reserved is non-reservable. Specifically, the administrator side registers a reservation in the time period before or after the time period to be reserved, thereby adjusting the reservation such that the time periods of reservations do not become consecutive without an empty time in between.

As illustrated in FIG. 13, in the reservation management server 30, the operation reception unit 112 receives information about a desired time period during which to reserve the booth 10A transmitted from the reserver terminal 20 (S201), and temporarily holds the desired time period in the reservation management database 119 (S202).

Thereafter, the reservation management server 30 acquires the registered reservation information held in the reservation management database 119 (S203), and determines whether a reservation preceding the time period of the received reservation is registered (S204). In the case of determining that a preceding reservation is registered (S204: Yes), the administrator side registers the reservation (S206), and the reserver terminal 20 is notified with guidance information regarding the consecutive reservations (S206).

In the case where a preceding reservation is not registered (S204: No), it is determined whether a reservation succeeding the time period of the received reservation is registered (S205). In the case where a succeeding reservation is registered (S205: Yes), the administrator side registers the reservation (S206).

In the case where a succeeding reservation is not registered (S205: No), the time period of the received reservation is registered (S207), and the registered reservation information is updated (S208).

With this arrangement, as exemplified in FIG. 14, in the case where a reservation is registered for the period “9:00-9:15” (preceding), the empty period “9:15-9:30” is also registered and made non-reservable, and in the case where a reservation is registered for the period “10:30-10:45” (succeeding), the period “10:15-10:30” is also registered and made non-reservable. In this way, by forcibly registering a reservation on the administrator side and making reservation unavailable to reservers in the case where the time period of the reservation is consecutive with another reservation without an empty time in between, consecutive use of the booth 10A by different users is avoided, thereby reducing the risk of infectious diseases and the like.

Note that in the case where a reserver cancels a reservation, the administrator side cancels the registered reservation and reverts the canceled time period to a reservable state.

Also, in the case where the new reserver belongs to the same organization as the reserver of the time period of the already-registered reservation, the received new reservation is registered. The determination of whether or not the new reserver belongs to the same organization as the reserver of the time period of the already-registered reservation is achieved by referencing the member information and the reserver information registered in the member management server 60.

### Exemplary Modification 1

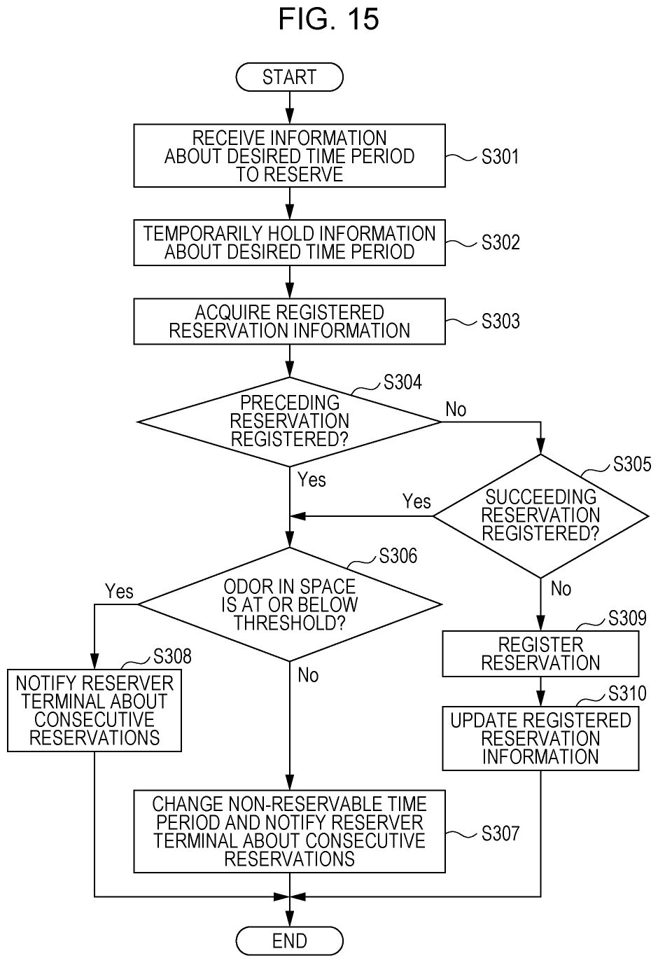

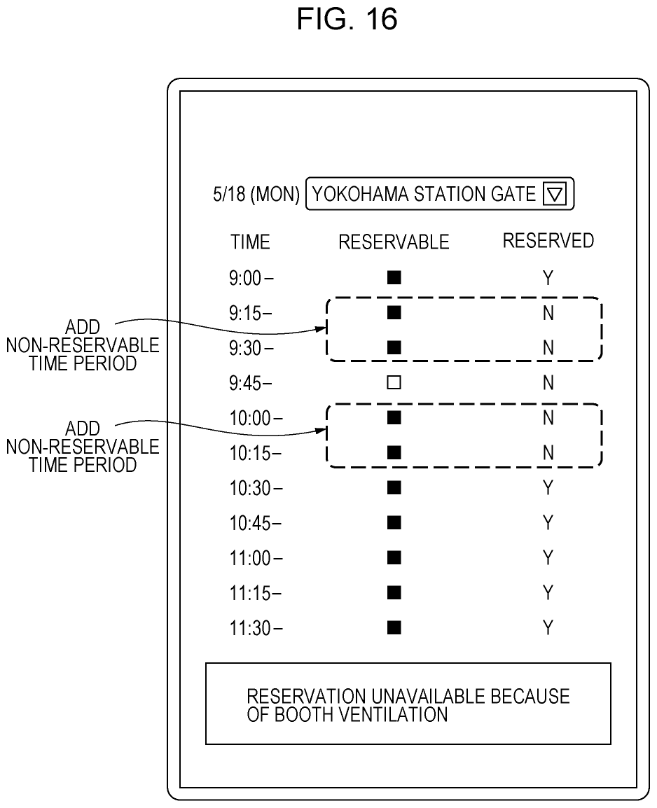

FIG. 15 is a flowchart illustrating a flow of operations for receiving a reservation according to an exemplary modification 1, the operations being executed by the reservation management server 30, and FIG. 16 is a diagram illustrating an example of a seventh error message displayed on the display device 107 of the reserver terminal 20.

In the case of receiving a reservation for the space 10 that is usable by making a reservation, the reservation management server 30 changes the length of a non-reservable time period between the time period of an already-registered reservation and the received reservation according to information about the odor in the space 10. Specifically, in the case where the odor in the space 10 exceeds a predetermined threshold, a non-reservable time period is added to the time period before or after the time period to be reserved, thereby promoting the circulation of air inside the space.

As illustrated in FIG. 15, in the reservation management server 30, the operation reception unit 112 receives information about a desired time period during which to reserve the booth 10A transmitted from the reserver terminal 20 (S301), and temporarily holds the desired time period in the reservation management database 119 (S302).

Thereafter, the reservation management server 30 acquires the registered reservation information held in the reservation management database 119 (S303), and determines whether a reservation preceding the time period of the received reservation is registered (S304). In the case of determining that a preceding reservation is registered (S304: Yes), odor sensor information in the space management server 40 is referenced to determine whether the odor in the booth 10A is at or below a threshold (S306). In the case where the odor exceeds the threshold (S306: No), the non-reservable time period is changed, and the reserver terminal 20 is notified with guidance information regarding the consecutive reservations (S307).

In the case where the odor is at the threshold or below (S306: Yes), the non-reservable time period is not changed, and the reserver terminal 20 is notified with guidance information regarding the consecutive reservations (S308).

In the case where a preceding reservation is not registered (S304: No), it is determined whether a reservation succeeding the time period of the received reservation is registered (S305). In the case of determining that a preceding reservation is registered (S305: Yes), odor sensor information in the space management server 40 is referenced to determine whether or not the odor in the booth 10A is at or below a threshold (S306). In the case where the odor exceeds the threshold (S306: No), the non-reservable time period is changed, and the reserver terminal 20 is notified with guidance information regarding the consecutive reservations (S307).

In the case where a succeeding reservation is not registered (S305: No), the time period of the received reservation is registered (S309), and the registered reservation information is updated (S310).

With this arrangement, as exemplified in FIG. 16, in the case where a reservation is registered for the period “9:00-9:15” (preceding), the empty period “9:30-9:45” is made non-reservable in addition to “9:15-9:30”, and in the case where a reservation is registered for the period “10:30-10:45” (succeeding), the period “10:00-10:15” before the period “10:15-10:30” is made non-reservable. In this way, in the case where the odor in the booth 10A exceeds a predetermined threshold, a non-reservable time period is added to the time period before or after the time period to be reserved, thereby promoting the circulation of air inside the booth 10A to weaken the odor.

### Exemplary Modification 2

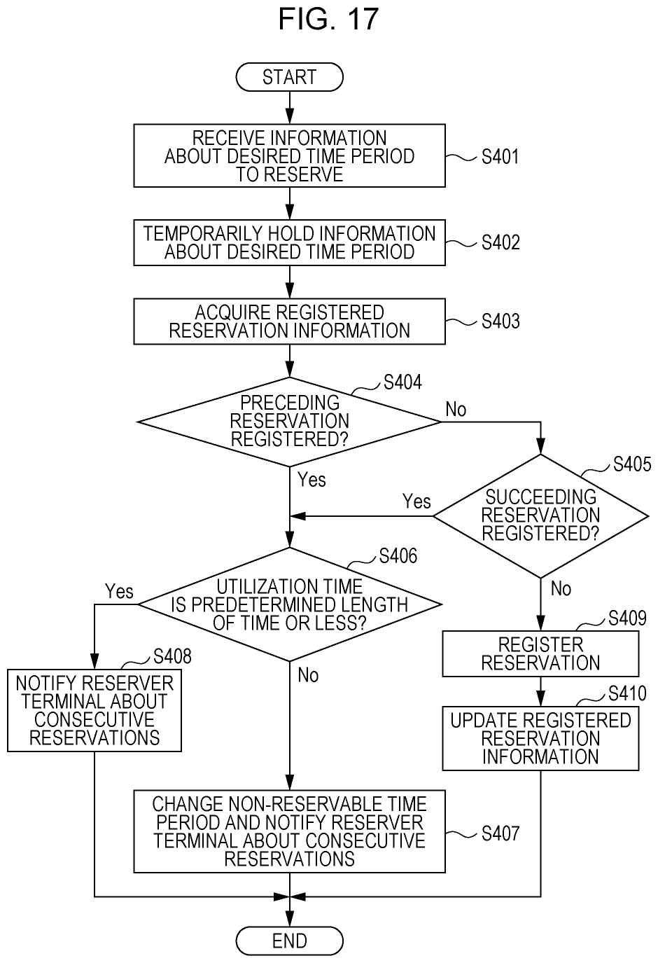

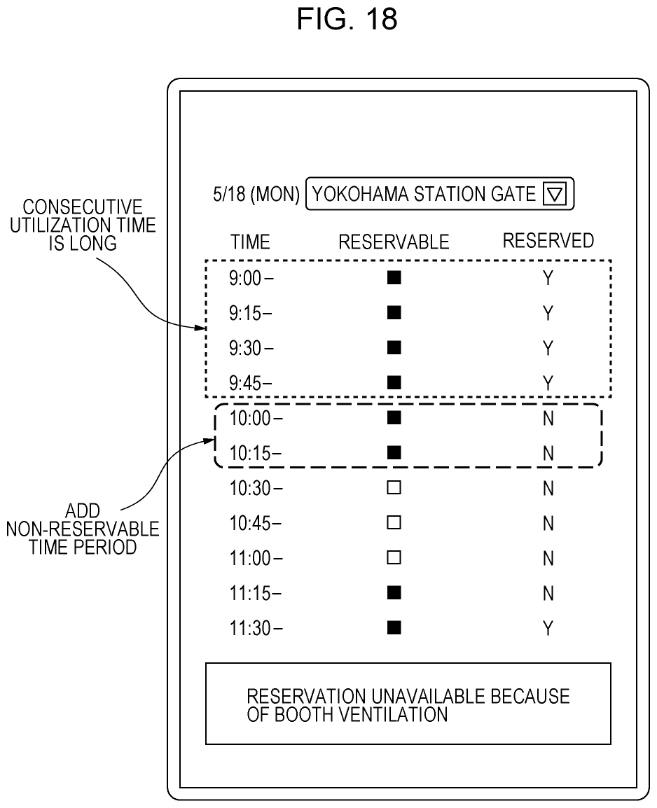

FIG. 17 is a flowchart illustrating a flow of operations for receiving a reservation according to an exemplary modification 2, the operations being executed by the reservation management server 30, and FIG. 18 is a diagram illustrating an example of an eighth error message displayed on the display device 107 of the reserver terminal 20.

In the case of receiving a reservation for the space 10 that is usable by making a reservation, the reservation management server 30 changes the length of a non-reservable time period between the time period of an already-registered reservation and the received reservation according to the length of the utilization time period of the space 10. Specifically, in the case where the continuous utilization time period of the space 10 exceeds a predetermined length of time, a non-reservable time period is added to the time period before or after the time period to be reserved, thereby promoting the circulation of air inside the space.

As illustrated in FIG. 17, in the reservation management server 30, the operation reception unit 112 receives information about a desired time period during which to reserve the booth 10A transmitted from the reserver terminal 20 (S401), and temporarily holds the desired time period in the reservation management database 119 (S402).

Thereafter, the reservation management server 30 acquires the registered reservation information held in the reservation management database 119 (S403), and determines whether a reservation preceding the time period of the received reservation is registered (S404). In the case of determining that a preceding reservation is registered (S404: Yes), utilization time information in the space management server 40 is referenced to determine whether the continuous utilization time period of the booth 10A is a predetermined length of time or less (S406). In the case where the continuous utilization time period exceeds the predetermined length of time (S406: No), the non-reservable time period is changed, and the reserver terminal 20 is notified with guidance information regarding the consecutive reservations (S407).

In the case where the continuous utilization time period is the predetermined length of time or less (S406: Yes), the non-reservable time period is not changed, and the reserver terminal 20 is notified with guidance information regarding the consecutive reservations (S408).

In the case where a preceding reservation is not registered (S404: No), it is determined whether a reservation succeeding the time period of the received reservation is registered (S405). In the case of determining that a succeeding reservation is registered (S405: Yes), utilization time information in the space management server 40 is referenced to determine whether the continuous utilization time period of the booth 10A is a predetermined length of time or less (S406). In the case where the continuous utilization time period of the booth 10A exceeds the predetermined length of time (S406: No), the non-reservable time period is changed, and the reserver terminal 20 is notified with guidance information regarding the consecutive reservations (S407).

In the case where a succeeding reservation is not registered (4305: No), the time period of the received reservation is registered (S409), and the registered reservation information is updated (S410).

With this arrangement, as exemplified in FIG. 18, in the case where the periods “9:00-9:15”, “9:15-9:30”, “9:30-9:45”, and “9:45-10:00” form a continuous utilization time period, the empty period “10:15-10:30” is made non-reservable in addition to “10:00-10:15”. In this way, in the case where the continuous utilization time of the booth 10A is greater than a predetermined length of time, a non-reservable time period is added to the time period before or after the time period to be reserved, thereby promoting the circulation of air inside the booth 10A.

### Exemplary Modification 3

In the case of receiving a reservation for the space 10 that is usable by making a reservation, the reservation management server 30 changes the length of a non-reservable time period between the time period of an already-registered reservation and the received reservation according to the number of users of the space 10. Specifically, in the case where the number of users of the space 10 exceeds a predetermined number, a non-reservable time period is added to the time period before or after the time period to be reserved, thereby promoting the circulation of air inside the space. The number of users of the space 10 is determined by referencing the member information and the reserver information registered in the member management server 60.

### Exemplary Modification 4

In the case of receiving a reservation for the space 10 that is usable by making a reservation, the reservation management server 30 changes the length of a non-reservable time period between the time period of an already-registered reservation and the received reservation according to the size of the space 10. Specifically, in the case where the size of the space 10 is a predetermined size or smaller, a non-reservable time period is added to the time period before or after the time period to be reserved, thereby promoting the circulation of air inside the space. The size of the space 10 is determined by referencing space size information in the space management server 40.

### Exemplary Modification 5

In the case of receiving a reservation for the space 10 that is usable by making a reservation, the reservation management server 30 changes the length of a non-reservable time period between the time period of an already-registered reservation and the received reservation according to the purpose of using the space 10. Specifically, in the case where the purpose of using the space 10 is as a storage space for belongings, and a person is present for a short length of time, the non-reservable time period set before or after the time period to be reserved is shortened, thereby raising the utilization ratio of the space.

In the exemplary embodiments, the reserver terminal 20 connects to the reservation management server 30 over the cloud network NW, but reservation management program software may also be installed in the reserver terminal 20 as a reservation application, and the reserver terminal 20 may be configured to acquire and update reservation information. With this arrangement, the reserver terminal 20 may be configured to acquire reservation information about external reservers using reserver terminals other than itself over a network, either periodically or in real time, and present error messages or register empty reservations.

Also, in the exemplary embodiments described above, guidance information and restrictions regarding reservations are described as being displayed, but the exemplary embodiments may also be carried out by substituting display notifications with changes in speech input and output, and the exemplary embodiments may also be carried out by partially combining both visual and audible notifications. Otherwise, any of various types of user interfaces may be applied where appropriate, such as a user interface that notifies a user in a tactile way using vibration.

In the embodiments above, the term “processor” refers to hardware in a broad sense. Examples of the processor includes general processors (e.g., CPU: Central Processing Unit), dedicated processors (e.g., GPU: Graphics Processing Unit, ASIC: Application Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing device comprising:
a processor configured to
in a case of receiving a reservation for a space that is usable by making a reservation, determine whether a time period of the reservation is consecutive with a time period of an already-registered reservation without an empty time in between, and if the time periods of the reservations are consecutive without an empty time in between, notify a reserver with guidance information.

2. The information processing device according to claim 1, wherein
the processor is configured to notify the reserver with a message in a case where the time periods of the reservations are consecutive without an empty time in between.

3. The information processing device according to claim 2, wherein
the processor is configured to instruct the reserver to leave a predetermined time period empty before and after the time period of the reservation.

4. The information processing device according to claim 2, wherein
the processor is configured to notify the reserver that the reservation is unavailable because another reservation is registered before or after the time period of the reservation.

5. The information processing device according to claim 1, wherein
in a case where a time period of a new reservation consecutive with the time period of the reservation is added, the processor is configured to notify the reserver that the reservation is unavailable.

6. The information processing device according to claim 1, wherein
in a case where a time period of a new reservation consecutive with the time period of the reservation is added, the processor is configured to notify the reserver that the reservation is unavailable with a reason therefor and also cause the notification to be displayed with a different appearance from a normal notification.

7. The information processing device according to claim 1, wherein
the processor is configured not to notify the reserver with a message in a case where a time period of a new reservation consecutive with the time period of the reservation is added by the same reserver.

8. The information processing device according to claim 1, wherein
in a case where a time period of a new reservation consecutive with the time period of the reservation is added by the same reserver, the processor is configured to notify the reserver that the reservation is available with a reason therefor and also cause the notification to be displayed with a different appearance from a normal notification.

9. An information processing device comprising:
a processor configured to
in a case of receiving, from a reserver, a reservation for a space that is usable by making a reservation, adjust the reservation such that a time period before or after the time period to be reserved is non-reservable.

10. The information processing device according to claim 9, wherein
the processor is configured to register the reservation in the time period of the reservation as made by an administrator.

11. The information processing device according to claim 10, wherein
in a case where the reservation received from the reserver is canceled, the processor is configured to cancel the reservation registered as made by the administrator.

12. The information processing device according to claim 9, wherein
in a case where a new reserver belongs to a same organization as a reserver of a time period of an already-registered reservation, the processor is configured to register a reservation by the new reserver.

13. The information processing device according to claim 9, wherein
the processor is configured to change the length of a non-reservable time period between a time period of an already-registered reservation and a time period of the received reservation according to information about an odor in the space.

14. The information processing device according to claim 9, wherein
the processor is configured to change the length of a non-reservable time period between a time period of an already-registered reservation and a time period of the received reservation according to a length of a utilization time period of the space.

15. The information processing device according to claim 9, wherein
the processor is configured to change the length of a non-reservable time period between a time period of an already-registered reservation and a time period of the received reservation according to a number of users of the space.

16. The information processing device according to claim 9, wherein
the processor is configured to change the length of a non-reservable time period between a time period of an already-registered reservation and a time period of the received reservation according to a size of the space.

17. The information processing device according to claim 9, wherein
the processor is configured to change the length of a non-reservable time period between a time period of an already-registered reservation and a time period of the received reservation according to a purpose of using the space.

18. A non-transitory computer readable medium storing a program causing a computer to execute a process for processing information, the process comprising:
receiving, from a client device, a desired reservation time period during which a reserver desires to use a space that is usable by making a reservation; and
determining whether the desired reservation time period is consecutive with a time period of an already-registered reservation, and in a case where the desired reservation time period is consecutive, causing a notification to be displayed on the client device.

19. A non-transitory computer readable medium storing a program causing a computer to execute a process for processing information, the process comprising:
receiving, from a client device, a desired reservation time period during which a reserver desires to use a space that is usable by making a reservation; and
adjusting the reservation such that a time period before or after the time period to be reserved is non-reservable.
